(19) United States
(12) Patent Application Publication
(10) Pub. No.: US 2026/0322922 A1
(43) Pub. Date: Oct. 15, 2026

(54) ENHANCED EMERGENCY EVALUATION SYSTEM

(71) Applicant: CK Technologies, LLC, Washington, DC (US)

(72) Inventors: Natalie Khawam CASE, Tierra Verde, FL (US); Michael Timothy CASE, Tierra Verde, FL (US)

(73) Assignee: CK Technologies, LLC, Washington, DC (US)

(21) Appl. No.: 19/414,139

(22) Filed: Dec. 9, 2025

Related U.S. Application Data
(60) Provisional application No. 63/788,179, filed on Apr. 14, 2025.

(51) Int. Cl. H04M 11/04; G06F 40/35

(52) U.S. Cl. CPC H04M 11/04; G06F 40/35

(57) ABSTRACT

A system and method for enhancing emergency call processing and responses includes an emergency application for mobile communication devices which is configured to collect emergency data from on-device components and external devices, such as video, audio, biometrics, and other sensors data, and transmit this information to a Public Safety Answering Point (PSAP) application during emergency calls. The PSAP application is capable of connecting to the emergency application for remote control of the on-device components and external devices of the mobile communication device during emergency calls. The PSAP application provides the emergency data to an emergency data evaluation system which utilizes a network of AI models to process the emergency data to generate insights pertaining to the emergency data. The insights and emergency data can then be provided to first responders to improve response times, situational awareness, and preparation for emergencies.

### CROSS-REFERENCE TO RELATED APPLICATION

This application claims the benefit of priority to U.S. Provisional Application No. 63/788,179 titled “Enhanced Emergency Evaluation System” and filed Apr. 14, 2025. The entire contents of the above-referenced application is incorporated herein by reference.

### BACKGROUND

Current 911 systems are primarily reliant on voice communication and therefore lack the capabilities necessary to meet modern emergency response needs. These systems often fail to provide first responders with crucial real-time visual context which delays critical decision-making and lifesaving actions. Operators frequently rely on verbal descriptions from callers in stressful situations which can be incomplete, unclear, or inaccurate, particularly for individuals unable to speak due to injury or danger. Furthermore, modern technologies like video calling, Artificial Intelligence (AI), and biometric data integration remain underutilized in emergency services, despite their proven potential to enhance situational awareness and response efficiency. Additionally, the existing system poses barriers for non-English speakers, individuals with disabilities, and those in situations where traditional voice communication is not feasible, limiting equitable access to emergency support.

Hence, finding ways to improve the ability of 911 systems to obtain relevant information pertaining to 911 communications and provide this information to first responders in real-time is an ongoing concern.

### SUMMARY

In one general aspect, the instant disclosure presents an emergency call processing system that includes an emergency application configured to be installed on a mobile communication device. The emergency application is programmed to: activate on-device components of the mobile communication device while an emergency call is being made to a public safety answering point (PSAP) in order to collect emergency data pertaining to a user of the mobile communication device and/or an environment surrounding the mobile communication device, the emergency data including video from at least on-device video camera, and audio from an on-device microphone, and sensor data from one or more sensors integrated into the mobile communication device; activate external devices that the mobile communication device is connected to and/or in communication with to collect supplementary emergency data including video, audio, and biometric data; and transmit the collected emergency data to the PSAP over a network via a secure communication channel. The emergency call processing also includes a PSAP application configured to be installed in a PSAP computing device and programmed to receive the emergency call from the mobile communication device and to establish the secure communication channel with the emergency application via which the emergency data as well as verbal communication pertaining to the emergency call is communicated, and an emergency data evaluation system that includes an artificial intelligence (AI) model network for processing the emergency data associated with the emergency call. The AI model network includes at least one AI model trained to analyze at least one component of the emergency data to determine insights pertaining to the emergency call. The at least one component includes the video, audio, and/or biometric data. The insights provide contextual information pertaining an emergency for which the emergency call is being made. The PSAP application and/or the emergency data evaluation system is configured to combine the emergency data and the determined insights into a first responder data feed and to transmit the first responder data feed to at least one first responder device.

In yet another general aspect, the instant disclosure presents a method for operating an emergency call processing system. The method comprises receiving an emergency call at a public safety answering point (PSAP) from a mobile communication device, the mobile communication device including an emergency application installed thereon, the emergency application being programmed to activate on-device components of the mobile communication device and external devices controllable by the mobile communication device while the emergency call is being made; in response to receiving the emergency call, routing the call to a PSAP computing device having a PSAP application installed thereon, establishing a secure communication channel between the PSAP application and the emergency app; in response to the secure communication channel being established, transmitting at least one command from the PSAP application to the emergency application to cause the emergency application to activate at least one on-device component of the mobile communication device to collect emergency data pertaining to a user of the mobile communication device and/or an environment surrounding the mobile communication device and transmit the emergency data to the PSAP application; receiving the emergency data at the PSAP application and providing the emergency data from the PSAP application to an emergency data evaluation system that includes an artificial intelligence (AI) model network for processing the emergency data, the AI model network including at least one AI model trained to analyze at least one component of the emergency data to determine insights pertaining to the emergency call, the insights providing contextual information pertaining an emergency for which the emergency call is being made; and transmitting the emergency data and the insights to an emergency service using the PSAP application.

In a further general aspect, the instant application presents a method for operating a mobile communication device for an emergency call processing system. The method includes detecting activation of an emergency call on the mobile communication device using an emergency application installed on the mobile communication device, the emergency application being programmed to activate on-device components of the mobile communication device and external devices controllable by the mobile communication device while the emergency call is being made; automatically activating on-board components of the mobile communication device to begin collecting emergency data pertaining to the emergency call, the on-board components including at least a camera and a microphone, the emergency data including video generated by the camera and audio generated by the microphone; establishing a secure communication channel with a public safety answering point (PSAP) application installed on a PSAP computing device at a PSAP; transmitting the emergency data to the PSAP application via the secure communication channel; receiving a command from the PSAP application via the secure communication channel instructing the emergency application to activate at least one external device of the mobile communication device to collect data pertaining to a user and/or an environment pertaining to the emergency call and to include the collected data in the emergency data transmitted to the PSAP application; receiving a first responder communications from a first responder application installed on a first responder device, the first responder communication including at least one of audio, video, and text data; and presenting the first responder communication on the mobile communication device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is an example environment in which aspects of the disclosure may be implemented.

FIG. 2 shows an example implementation of an emergency data evaluation system which may be used in environment of FIG. 2

FIG. 3 shows a flowchart of an example method for operating a PSAP for an emergency call processing system.

FIG. 4 shows a flowchart of an example method for operating a mobile communication device for an emergency call processing system.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

The 911 emergency system is a critical infrastructure that connects individuals in distress with public safety services such as police, fire, and medical responders. When a person dials 911, the call is automatically routed to a Public Safety Answering Point (PSAP). A PSAP is a centralized communication center that receives and processes 911 calls. When an individual dials an emergency number, the call is routed based on location, either through a landline's registered address or a mobile phone's network-based or GPS-derived location. The call is answered by a trained dispatcher at the PSAP, who gathers critical information, assesses the urgency, and determines the appropriate emergency response, such as dispatching the appropriate emergency services or transferring calls to other specialized agencies.

911 systems have typically relied on voice communications over analog phone lines to enable users to request emergency services. Such analog systems, however, lack the capabilities necessary to meet modern emergency response needs. Efforts are currently underway to modernize 911 systems by enabling digital communications and multimedia data transmissions over IP-based infrastructures, such as the Internet. These advancements enable fast and reliable location determinations for incoming 911 calls and improve the accessibility of the system for non-English speakers, individuals with disabilities, and those in situations where traditional voice communication is not feasible by allowing communication through text messages, video, and other digital forms of communication.

However, even with these improvements, 911 systems are still limited in their ability to obtain relevant information pertaining to 911 communications. For example, 911 systems frequently rely almost exclusively on verbal descriptions from distressed callers, which can be incomplete, unclear, or inaccurate, particularly in high-stress situations or for individuals unable to speak due to injury or danger. The difficulties associated with obtaining emergency contextual information verbally can delay decision-making and in turn delay response times for lifesaving actions. In addition, verbal communications may not provide first responders with enough contextual information to adequately prepare for a given emergency. Finding ways to improve the ability of 911 systems to obtain relevant information pertaining 911 communications in real-time is therefore an ongoing concern.

Smartphones and similar types of devices are capable of collecting a wealth of information pertaining to the users of those devices and the surrounding environment. For example, smartphones typically have front-face and rear-facing video cameras for capturing images and video and microphones for capturing audio. Smartphones also typically have GPS capabilities which enable the current location of phone to be tracked, and sensors, such as accelerometers, which can indicate speed and direction of movement. Smartphones are also capable of connecting to external devices and sensors. For example, smartphones can connect to biometric sensors which enable biometric information, such as heart rate, blood pressure, and the like, of the user to be monitored and collected, and to devices, such as video cameras and microphones of a home automation or security system. Unfortunately, 911 systems are generally not capable of accessing all the information that a caller's smartphone is capable of collecting, and, even if 911 systems were capable of retrieving this information, 911 systems are not capable of processing this information in a manner that would be beneficial to dispatchers or first responders.

The present disclosure is directed to technical solutions which address the technical problems and difficulties associated with enabling 911 systems to obtain relevant contextual information pertaining 911 communications and providing this information to first responders in real-time. These solutions include an emergency application, or app, for smartphones and similar types of devices that is capable of establishing emergency calls with a PSAP of an emergency system. The emergency application is configured to collect relevant digital information from an associated smartphone (with consent), such as current audio, video, and sensor data, and transmit the emergency data to the PSAP during emergency calls. The solutions also include a PSAP application for PSAPs for connecting to the emergency application during emergency calls and receiving the emergency data associated with the emergency calls. The PSAP application may also be configured to interact with the emergency application to remotely activate devices (e.g., video camera, microphone, sensors, etc.) to collect data and adjust settings (e.g., zoom) in order to improve the quality of collected data. The PSAP application can also activate other on-device components, such as a flashlight and alarm(s), which can make it easier for first responders to locate the user of the device.

The solutions also include an emergency data evaluation system capable of receiving emergency data from the PSAP application and/or the emergency application and evaluating the data to glean contextual information pertaining to the calls, also referred to herein as insights. The emergency data evaluation system utilizes artificial intelligence (AI)-based analytics to process the emergency data to generate the insights. These insights can indicate the type of emergency associated with an emergency call and contextual information pertaining to the call, such as location, condition of caller, condition of environment, information about other individuals in the environment, tone and type of interactions between individuals, threat potential, and the like. Insight information can be provided to first responders along with audio and video pertaining to the emergency in real-time, so that first responders have knowledge of the situation they are entering that they would otherwise not have. This knowledge can result faster response times, improved situational awareness, and better preparation for first responders.

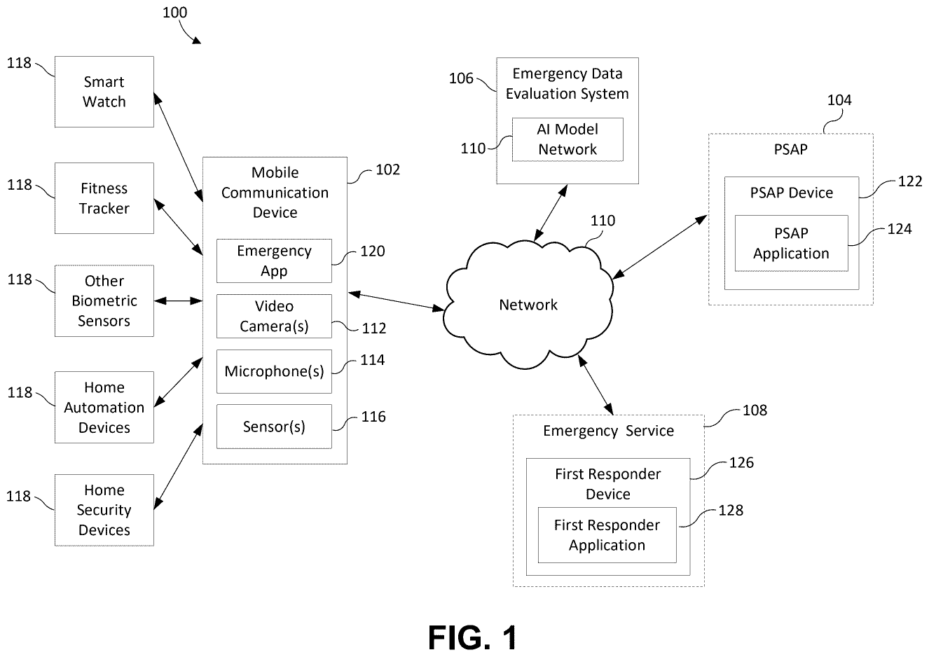

FIG. 1 illustrates an example environment 100 in which aspects of this disclosure may be implemented. The environment 100 includes a mobile communication device 102, a PSAP 104, an emergency data evaluation system 106, and an emergency service 108 which communicate via a network 110. The network 110 includes one or more wired, wireless, and/or a combination of wired and wireless networks. In embodiments, the network 110 includes one or more local area networks (LAN), wide area networks (WAN) (e.g., the Internet), public networks, private networks, virtual networks, mesh networks, peer-to-peer networks, satellite networks, and/or other interconnected data paths across which multiple devices may communicate.

The mobile communication device 102 includes a smartphone, tablet, laptop, or other suitable type of computing device which is capable of making calls and establishing communication channels via the network 110, including emergency calls to the emergency system. To this end, the mobile communication device includes at least one video camera 112 and at least one microphone 114. The mobile communication device 102 also includes one or more sensors 116 configured to detect one or more parameters pertaining to the mobile communication device and/or environment around the mobile communication device. For example, the mobile communication device 102 can include one or more accelerometers which are configured to detect movement information, such as speed and direction of travel. The one or more sensors can also include a temperature sensor, humidity sensor, pressure sensor, and/or the like.

The mobile communication device 102 may be connected to receive video, audio, biometric, and other sensors data from one or more external devices 118. These external devices 118 can include smart watches, fitness trackers, biometric information sensors, implantable medical devices, home automation systems, home security systems, and the like. Examples of biometric sensors that may be accessed to retrieve biometric information include heart rate monitors, blood sugar monitors, blood pressure sensors, fall detection sensors, and any sensor, detector, or device capable of sensing a biological characteristic which could be used to determine the status of the individual to which the emergency call pertains. The mobile communication device 102 may be configured to communicate with external devices in any suitable manner, such as Bluetooth®, Wi-Fi direct, Near Field Communication (NFC), Zigbee, Z-wave, and the like.

Each mobile communication device 102 includes an emergency application 120 which facilitates the establishment of connections and/or communication channels with a PSAP of the emergency system. The emergency application 120 is a software application designed to be installed and executed on mobile devices, such as smartphones, tablets, and the like. In some implementations, the emergency application 120 is an application which is provided and maintained by a third-party. In these embodiments, the emergency application 120 can be downloaded from a digital marketplace, such as the Apple Application Store (iOS) or Google Play Store (Android). In other implementations, the emergency application 120 is a built-in application which is integrated into the operating system of the mobile communication device 102 and maintained by the provider of the operating system.

In various implementations, emergency calls can be initiated via the emergency application 120. In some implementations, the emergency application 120 may be configured to activate in response to a user interacting with a phone application on the mobile communication device 102 to make an emergency call. The emergency application 120 is designed to connect to on-device components, such as front-facing and rear-facing video cameras 112, microphones 114, sensors (e.g., accelerometers) 116, antennas, communication components, and the like, with permission from the user during emergency calls. The emergency application 120 receives video data, audio data, biometric, and sensor data from the on-device components during the emergency call and transmits the data as emergency data to the PSAP 104 of the emergency system. In addition to cellular and Wi-Fi connectivity, the emergency application may be designed to utilize satellite communication components if the mobile device includes such components. The emergency application is capable of determining whether the mobile device has satellite communication capability, and, in situations where cellular service and Wi-Fi is not available, the emergency application can switch to satellite communication mode.

The emergency application 120 may also be designed to connect (with permission from the user) to the external devices 118 which the mobile communication device 102 is connected to and/or has access to. In this case, the emergency application 120 may be configured to activate the external devices 118 to capture video, audio, biometric, and/or sensor data during emergency calls and to include this data with the emergency data that is transmitted to the PSAP 104. In various implementations, the emergency application 120 may be configured to automatically connect to wearable and implanted biometric devices and transmit biometric data and notifications from these devices directly to the PSAP 104. In this way, alerts generated by a biometric device indicating a potential medical emergency can be quickly provided to the PSAP 104 so that appropriate actions may be taken. As noted above, biometric sensors can include heart rate monitors, blood sugar monitors, blood pressure sensors, fall detection sensors, and any sensor, detector, or device capable of sensing a biological characteristic which could be used to determine the status of the individual to which the emergency call pertains.

The PSAP 104 is part of an emergency system or network. The PSAP 104 is a type of call center capable of receiving emergency calls via landline, mobile phone network, and digital communication networks, including the Internet. Emergency calls may be routed to the appropriate PSAP 104 based on location, either through a landline's registered address or a mobile phone's network-based or GPS-derived location. The PSAP 104 includes dispatchers, or operators, which answer emergency calls using PSAP devices, such as PSAP device 122, and talks to the individual(s) making the call in an effort to gather relevant information. Based on this information, the dispatcher contacts one or more emergency services (i.e., police, fire department, poison control, etc.), such as emergency service 108, which are capable of responding to the emergency associated with each call. The emergency services contacted in association with an emergency call then send first responders to location of the emergency indicated by the call.

The PSAP device 122 is a computing device, such as a desktop computer, laptop computer, tablet, smartphone, or the like. The PSAP device 122 includes a PSAP application 124 which is programmed to establish communications with the emergency application 120 installed on the mobile communication device via the network 110. The PSAP application 124 is a software application, which may be installed on the PSAP device 122. The PSAP application 124 is activated in response to receiving an emergency call, which may be routed to the PSAP device 122 via the network. The PSAP application 124 and the emergency application 120 are programmed to utilize any suitable communication method(s) and/or protocol(s) to establish a secure communication channel via which data and information for the emergency call is transmitted between the emergency application 120 installed on the mobile communication device 102 and the PSAP application 124 installed on the PSAP device 122.

The PSAP application 124 receives the emergency data from the emergency application 120 during an emergency call and can route the data to other systems according to guidelines established by the PSAP and/or the local municipality where the PSAP is located. The PSAP application 124 is also programmed to enable data to be transmitted back to the emergency application 120. The data transmitted to the emergency application 120 can include communication data and command and control data. The communication data can include communications, such as audio, video, text, and the like from PSAP personnel as well as first responders. The command and control data can include commands instructing the emergency application to provide information identifying the capabilities of the mobile communication device 102, such as capabilities of the mobile communication device 102, type and status (e.g., on or off) of on-board components and electrical devices. In some implementations, the mobile communication device 102 may transmit the device information, such as manufacturer, brand, model, serial number, MAC address, etc. which can be used at the PSAP 124 to determine the capabilities of the mobile communication device 102. The commands can also include instructions for causing the emergency application 120 to interact with the mobile communication device 102 to cause the mobile communication device 102 to activate on-device components and external devices as needed to collect emergency data, e.g., video, images, audio, biometric information, etc.

The PSAP application 124 may cause certain components of the mobile communication device 102 to be activated automatically, such as the on-board camera, microphone, and speaker. The PSAP application 124 may also include a user interface which has user interface controls for displaying information pertaining to the mobile communication device 102, such as available on-device components and external devices and the status (e.g., on or off) of the components and devices. The user interface controls may also include controls enabling activation/deactivation of the components and devices as well as adjustments of settings where applicable. For example, if an emergency call is made via a mobile communication device which is connected to an external home security system, the dispatcher may decide to activate and collect data from the home security system. Remote control of components and devices may be especially useful in situations where the user of the phone is not capable of activating a component or device. In some cases, the PSAP application 124 may be configured to activate a speaker on the phone so that the dispatcher can talk via the speaker to whoever may be present at the site of the emergency if needed.

As noted above, the PSAP application 124 can also activate other on-device components, such as a flashlight and alarm(s), which can make it easier for first responders to locate the user of the device. In addition to remote control capabilities, the PSAP application 124 also enables video, images, and text to be transmitted to the emergency application 120 of mobile device 102. Video, images, and text can include instructions for actions that the user or a third party can perform depending on the emergency situation. Images can be annotated with textual information which can make instructions easier to understand. For example, in managing a large wound on a person's leg, an operator could send an annotated image showing where to apply a tourniquet. In collecting, storing, using and/or displaying any user data used in association with emergency calls and emergency call evaluations, care is taken to comply with privacy guidelines and regulations. For example, options may be provided to seek consent (e.g., opt-in) from users for collection and use of user data, to enable users to opt-out of data collection, and/or to allow users to view and/or correct collected data. The emergency data evaluation system 106 is configured to receive emergency data from PSAPs, such as PSAP 104, and to evaluate the emergency data to generate insights pertaining to the emergency data. In some implementations, the emergency data evaluation system 106 is a cloud-based service which receives emergency data from PSAP application 124 and processes the emergency data to generate the insights. In other implementations, the emergency data evaluation system 106 is implemented locally at the PSAP 104. As noted above, insights can include the type of emergency associated with the emergency call, emergency services which should be contacted to respond to the call, and relevant contextual information pertaining to the call, such as location, condition of caller, condition of environment, information about other individuals in the environment, tone and type of interactions between individuals, threat potential, and the like. Insights pertaining to emergency data are returned to the PSAP application 124 from which the emergency data was received. Please note that all data transmitted to the PSAP is securely migrated and stored in secured cloud storage.

The PSAP application 124 receives the insights pertaining to an emergency call and provides the insights along with relevant emergency data (e.g., video, audio, biometrics, and sensor information depending on the type of emergency) to the emergency service(s), and in particular the first responders, which are dispatched to the location associated with an emergency call. First responders for an emergency service, such as emergency service 108, include a first responder device 126. First responder devices comprise a portable or mobile computing device, such as a tablet, smartphone, laptop, and the like. First responder devices 126 include a first responder application 128 via which emergency data and insights for an emergency call are received from the PSAP application 124.

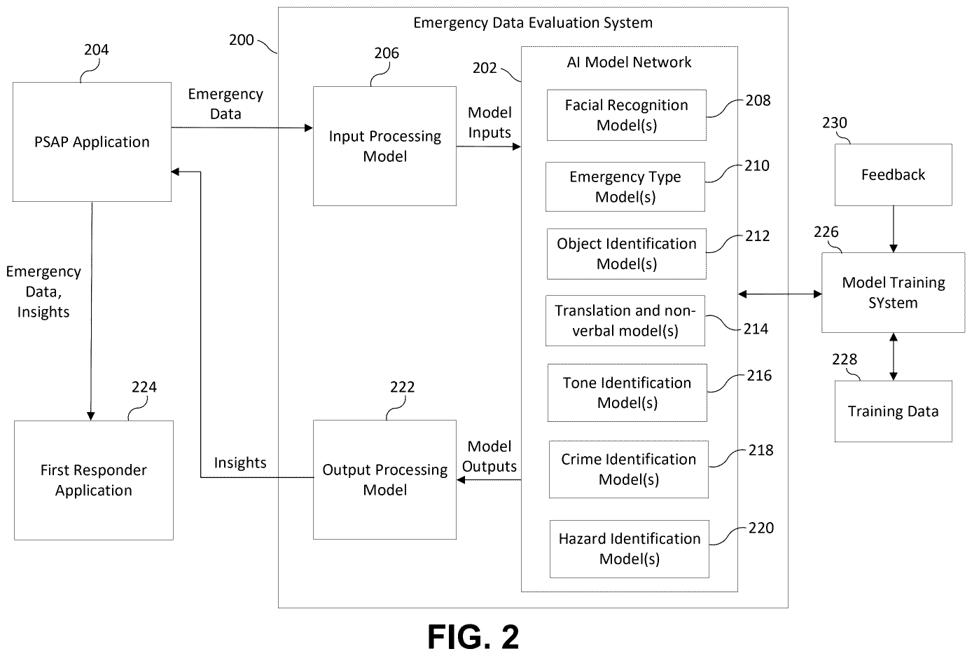

An example implementation 200 of the emergency data evaluation system including an AI model network 202 and showing how data can be communication between PSAP and first responders is shown in FIG. 2. A PSAP application 204 transmits emergency data to the emergency data evaluation system 200. The system 200 includes an input processing model 206 which receives the emergency data (e.g., video, audio, text, biometric) from the emergency app) and processes the emergency data to generate inputs for the AI models of the AI model network 202. For example, the input processing model may be trained to compile emergency data with pred-defined instructions and queries to generate one or more prompts which are provided to other AI models. The AI model network 202 is configured to use AI models to evaluate and analyze the emergency data to generate the insights. The AI models may comprise any type of AI model, including Generative Adversarial Networks (GANs), Variational Autoencoders (VAEs), Transformer-based models, diffusion models, and the like. Different models may be trained to process one or more components of the emergency data (e.g., video, audio, biometrics, sensor information, etc.) based on different factors to detect characteristics indicative of a particular event, condition, behavior, and the like.

As is known in the art, the output of an AI model is typically a probability distribution which assigns a probability to a plurality of different outputs that the AI model is trained to predict based on the given input. In various implementations, the output or outputs with the highest probability and/or that exceed a predetermined threshold value are then selected as the predicted output associated with the input. For example, for a model trained to process inputs to whether and what type of crime is being committed may be trained to identify many different types of crimes. The model is trained to process the inputs and assign a probability to each type of crime based on the input. The crime or crimes with the highest probability and/or that exceed a predetermined threshold may then be selected as the output for the model.

Examples of AI models that may be included in the AI model network 202 include one or more facial recognition models 208 which are trained to identify and recognize faces, one or more emergency type identification models 210 which are trained to identify types of emergencies (e.g., crime, fire, etc.), one or more object identification models 212 which are trained to identify objects, such as weapons, one or more translation and non-verbal communication models 214 trained to translate languages and to process non-verbal cues, such as facial and hand gestures, to determine what is being communicated, one or more tone identification models 216 which are trained to process speech patterns and/or facial features indicative of tone or emotion pertaining to interactions between individuals, one or more crime identification models 218 trained to identify types of crimes, and one or more hazard identification models 220 trained to identify various types of hazardous conditions. The AI models shown in FIG. 2 are only examples of some of the AI models which can be implemented for the evaluation system. AI models which are trained to classify, predict, and identify substantially any condition, behavior, situation, etc. can be included in the evaluation system as needed. In addition, although separate models are shown for implementing the functionality provided by the AI model network 202, some models may be trained to provide multiple recognition/identification capabilities.

The emergency system may include a model training system 226 to provide initial and ongoing training of the AI models. In various implementations, emergency data collected by the PSAPs of an emergency system can be anonymized and utilized as training data 228 for the models which can be continuously updated over time. In addition, feedback 230 collected from operators and users can be used to modify training data, e.g., by adjusting weights assigned to different parameters that the model are trained on. For example, PSAP operators may have the ability to flag and report inaccurate AI-generated recommendations, thereby further refining and training the AI system.

Models may be trained to evaluate the emergency data to detect a variety of information. For example, an AI model may be trained to process the emergency data to detect fire emergencies, detect characteristics indicative of poison and/or biohazard emergencies, to identify if individuals are carrying weapons, to identify the tone/emotional characteristics of interactions. AI models may also be trained to process biometric data to identify the current state or health of the user (e.g., cardiac arrest, low blood pressure, slow pulse, etc.). AI models may also be trained to process video from multiple viewpoints to identify specifics of the environment or scene, such as number of individuals, structures in the vicinity, where individuals are located with respect to each other and the structures, etc. This information can be combined with information derived by other models to generate a map of the scene with locations and information pertaining to the individuals at the scene. AI models may also be used for translation and non-verbal communication analysis to ensure accessibility for non-English speakers and individuals with disabilities.

The outputs of the AI models of the AI model network 202 are provided to an output processing model 222 which is trained to process and combine the outputs to generate insights pertaining the emergency data. The insights can then be returned to the PSAP application 204. The PSAP application can then send the emergency data and insights to first responder applications 224 for the first responders which are dispatched to the location of an emergency.

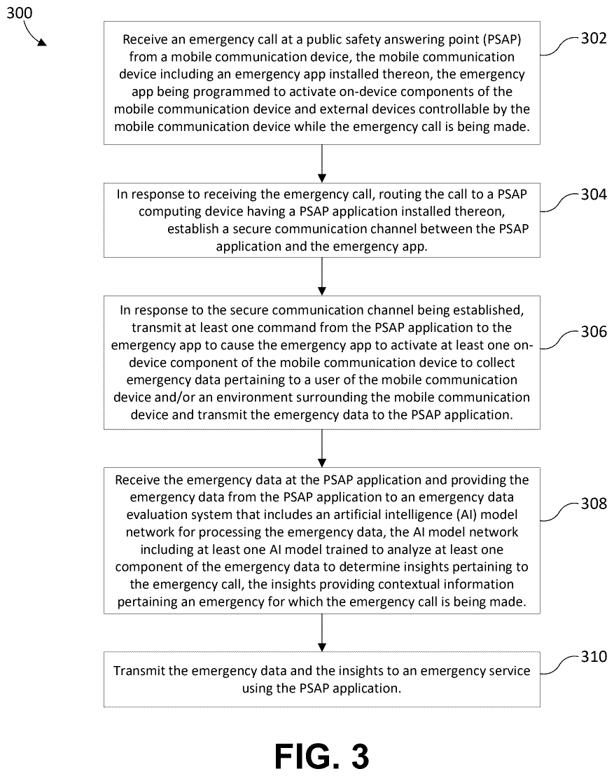

FIG. 3 shows a flowchart of an example method 300 for the emergency call processing system on the PSAP side. The method begins with receiving an emergency call at a public safety answering point (PSAP) from a mobile communication device (block 302). The mobile communication device includes an emergency application installed thereon that is programmed to activate on-device components of the mobile communication device and external devices controllable by the mobile communication device while the emergency call is being made. In response to receiving the emergency call, the call is routed to a PSAP computing device having a PSAP application installed thereon, a secure communication channel is established between the PSAP application and the emergency application (block 304). In response to the secure communication channel being established, at least one command is transmitted from the PSAP application to the emergency application to cause the emergency application to activate at least one on-device component of the mobile communication device to collect emergency data pertaining to a user of the mobile communication device and/or an environment surrounding the mobile communication device and transmit the emergency data to the PSAP application (block 306). The emergency data is received at the PSAP application and then provided from the PSAP application to an emergency data evaluation system that includes an artificial intelligence (AI) model network for processing the emergency data (block 308). The AI model network includes at least one AI model trained to analyze at least one component of the emergency data to determine insights pertaining to the emergency call. The insights provide contextual information pertaining an emergency for which the emergency call is being made. The emergency data and the insights are then transmitted to an emergency service using the PSAP application (block 310).

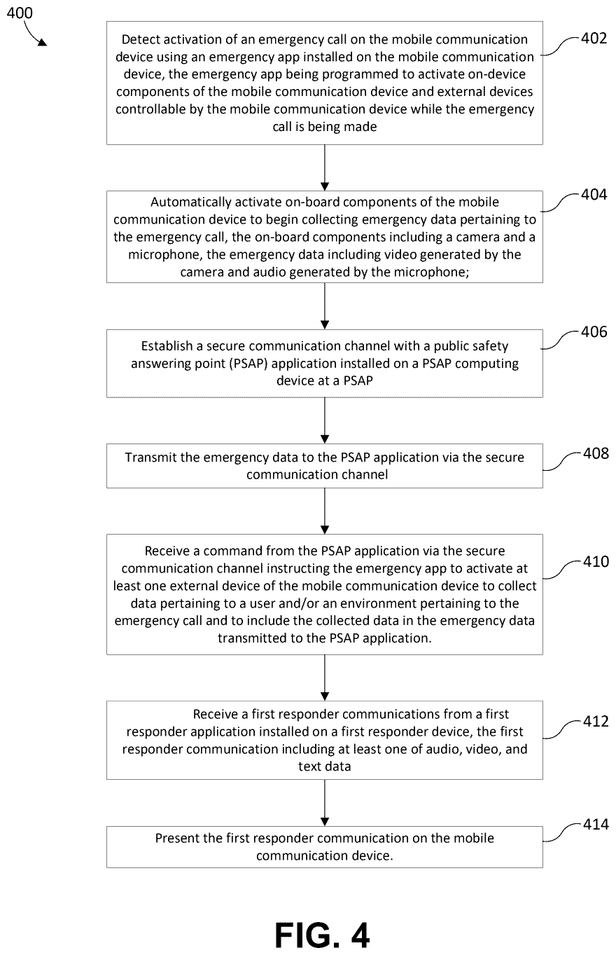

FIG. 4 shows a flowchart of an example method 400 for the emergency call processing system on the mobile communication device side. The method begins with detecting activation of an emergency call on the mobile communication device using an emergency application installed on the mobile communication device (block 402). The emergency application is programmed to activate on-device components of the mobile communication device and external devices controllable by the mobile communication device while the emergency call is being made. On-board components of the mobile communication device are then automatically activated to begin collecting emergency data pertaining to the emergency call by the emergency (block 404). The on-board components include a camera and a microphone. The emergency data includes video generated by the camera and audio generated by the microphone. A secure communication channel is the established with a public safety answering point (PSAP) application installed on a PSAP computing device at a PSAP (block 406). The emergency data is then transmitted to the PSAP application via the secure communication channel (block 408). A command is received from the PSAP application via the secure communication channel instructing the emergency application to activate at least one external device of the mobile communication device to collect data pertaining to a user and/or an environment pertaining to the emergency call and to include the collected data in the emergency data transmitted to the PSAP application (block 410). A first responder communications is received from a first responder application installed on a first responder device (block 412). The first responder communication is then on the mobile communication device (block 414).

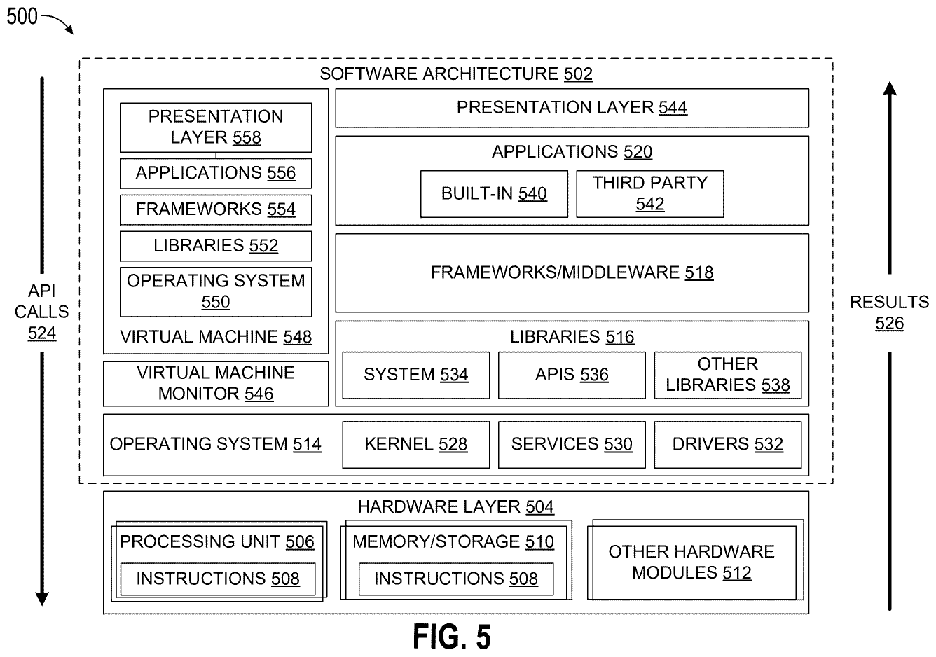

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks/middleware 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks/middleware 518 (also sometimes referred to as middleware) provide a higher-level common infrastructure that may be used by the applications 520 and/or other software modules. For example, the frameworks/middleware 518 may provide various graphic user interface (GUI) functions, high-level resource management, or high-level location services. The frameworks/middleware 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks/middleware 518, and presentation layer 544 to create user interfaces to interact with users.

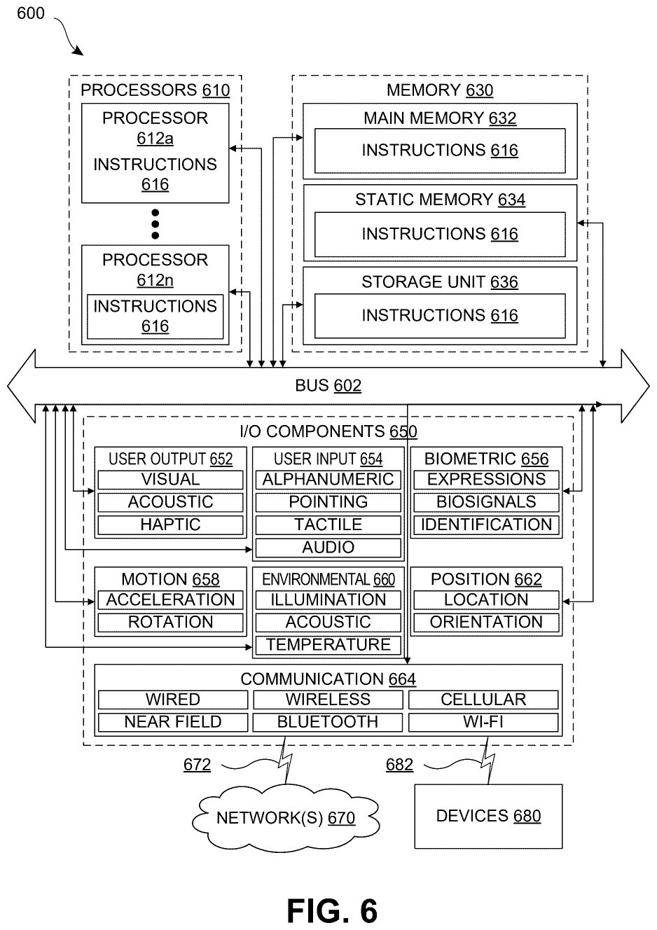

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machines to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IOT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

Communications over the network between computing devices are performed using the hardware, protocols, and standards required for the network types and for implementing desired security measures. For example, network communications hardware includes routers, switches, hubs, modems, firewalls, access points, and the like. Communication protocols can include Transmission Control Protocol (TCP), Internet Protocol (IP), User Datagram Protocol (UDP), and the like. Network communication standards are guidelines established for communications over different types of network, such as IEEE 802.3 (Ethernet), IEEE 802.1 (Wi-Fi), Bluetooth, and the like. Data may be transmitted via the network as packets. Each packet has a header which includes information for routing the packet to a destination, such as source address, destination address, sequencing information, and the like. Each packet also includes a payload which contains data being transmitted. Information to be transmitted may be divided into chunks which are added to the payloads of a plurality of packets which are transmitted over the network to a destination specified in the packet headers. The chunks are parsed to extract the data from the payload at the destination. The extracted data is then recombined to form the original information. The format of the packet, packet header, and payload depends on the protocols used to transmit the data over the network.

In some examples, the communication components 664 may detect identifiers or include components adapted to detect identifiers. For example, the communication components 664 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-4) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. An emergency call processing system comprising:
an emergency application configured to be installed on a mobile communication device, the emergency application being programmed to:
activate on-device components of the mobile communication device while an emergency call is being made to a public safety answering point (PSAP) in order to collect emergency data pertaining to a user of the mobile communication device and/or an environment surrounding the mobile communication device, the emergency data including video from at least one on-device video camera, and audio from an on-device microphone, and sensor data from one or more sensors integrated into the mobile communication device;
activate external devices that the mobile communication device is connected to and/or in communication with to collect supplementary emergency data including video, audio, and biometric data; and
transmit the collected emergency data to the PSAP over a network via a secure communication channel;
a PSAP application configured to be installed in a PSAP computing device and programmed to receive the emergency call from the mobile communication device and to establish the secure communication channel with the emergency application via which the emergency data as well as verbal communication pertaining to the emergency call is communicated; and
an emergency data evaluation system that includes an artificial intelligence (AI) model network for processing the emergency data associated with the emergency call, the AI model network including at least one AI model trained to analyze at least one component of the emergency data to determine insights pertaining to the emergency call, the at least one component including the video, audio, or biometric data, the insights providing contextual information pertaining to an emergency for which the emergency call is being made,
wherein the PSAP application and/or the emergency data evaluation system is configured to combine the emergency data and the determined insights into a first responder data feed and to transmit the first responder data feed to at least one first responder device, wherein the first responder device is separate from the mobile communication device.

2. The emergency call processing system of claim 1, wherein the emergency data evaluation system is implemented as a cloud-based service which is accessible via a computer network.

3. The emergency call processing system of claim 1, wherein the mobile communication device comprises a smartphone or tablet.

4. The emergency call processing system of claim 1, wherein the external devices include at least one of a smart watch, a fitness tracker, a biometric sensor device, a video and/or audio device of a home automation system or home security system.

5. The emergency call processing system of claim 4, wherein:
the PSAP application is programmed to transmit commands via the secure communication channel to the emergency application for causing the emergency application to activate one or more of the external devices, collect data generated by the one or more external devices, and transmit the collected data back to the PSAP application.

6. The emergency call processing system of claim 1, wherein the on-device components include at least one camera and at least one microphone.

7. The emergency call processing system of claim 1, wherein:
in response to receiving the emergency call, the PSAP application is programmed to transmit a command via the secure communication channel to the emergency application to cause the emergency application to activate at least one of the on-device components and/or external components.

8. The emergency call processing system of claim 6, wherein:
the on-device components further include a flashlight,
when the at least one camera is activated, the PSAP application is programmed to transmit a command via the secure communication channel to the emergency application to cause the emergency application to activate the flashlight.

9. The emergency call processing system of claim 1, wherein:
the PSAP application is programmed to transmit a command via the secure communication channel to the emergency application to cause the emergency application to generate an alarm via a speaker of the mobile communication device.

10. A method for operating an emergency call processing system, the method comprising:
receiving an emergency call at a public safety answering point (PSAP) from a mobile communication device, the mobile communication device including an emergency application installed thereon, the emergency application being programmed to activate on-device components of the mobile communication device and external devices controllable by the mobile communication device while the emergency call is being made;
in response to receiving the emergency call, routing the call to a PSAP computing device having a PSAP application installed thereon,
establishing a secure communication channel between the PSAP application and the emergency app;
in response to the secure communication channel being established, transmitting at least one command from the PSAP application to the emergency application to cause the emergency application to activate at least one on-device component of the mobile communication device to collect emergency data pertaining to a user of the mobile communication device and/or an environment surrounding the mobile communication device and transmit the emergency data to the PSAP application;
receiving the emergency data at the PSAP application and providing the emergency data from the PSAP application to an emergency data evaluation system that includes an artificial intelligence (AI) model network for processing the emergency data, the AI model network including at least one AI model trained to analyze at least one component of the emergency data to determine insights pertaining to the emergency call, the insights providing contextual information pertaining to an emergency for which the emergency call is being made; and
transmitting the emergency data and the insights to a first responder device of an emergency service using the PSAP application, wherein the first responder device is separate from the mobile communication device.

11. The method of claim 10, wherein the emergency data evaluation system is implemented as a cloud-based service which is accessible via a computer network.

12. The method of claim 10, further comprising:
transmitting at least one command from the PSAP application to the emergency application via the secure communication channel to cause the emergency application to activate at least one external device of the mobile communication device to collect data pertaining to the user and/or the environment and to include the data collected from the at least one external device in the emergency data transmitted to the PSAP application.

13. The method of claim 12, wherein the external devices include at least one of a smart watch, a fitness tracker, a biometric sensor device, a video and/or audio device of a home automation system or home security system.

14. The method of claim 10, wherein the at least one on-device component that is activated includes a camera and a microphone.

15. The method of claim 10, further comprising:
transmitting at least one command from the PSAP application to the emergency application via the secure communication channel to cause the emergency application to generate an alert via the mobile communication device by activating at least one of a speaker and a flashlight of the mobile communication device.

16. A method for operating a mobile communication device for an emergency call processing system, the method comprising:
detecting activation of an emergency call on the mobile communication device using an emergency application installed on the mobile communication device, the emergency application being programmed to activate on-device components of the mobile communication device and external devices controllable by the mobile communication device while the emergency call is being made;
automatically activating on-board components of the mobile communication device to begin collecting emergency data pertaining to the emergency call, the on-board components including at least a camera and a microphone, the emergency data including video generated by the camera and audio generated by the microphone;
establishing a secure communication channel with a public safety answering point (PSAP) application installed on a PSAP computing device at a PSAP;
transmitting the emergency data to the PSAP application via the secure communication channel;
receiving a command from the PSAP application via the secure communication channel instructing the emergency application to activate at least one external device of the mobile communication device to collect data pertaining to a user and/or an environment pertaining to the emergency call and to include the collected data in the emergency data transmitted to the PSAP application;
receiving a first responder communication from a first responder application installed on a first responder device, the first responder communication including at least one of audio, video, and text data, wherein the first responder device is separate from the mobile communication device; and
presenting the first responder communication on the mobile communication device.

17. The method of claim 16, wherein the emergency application is integrated into an operating system of the mobile communication device.

18. The method of claim 16, wherein the emergency application is provided and updated by a third party application provider.

19. The method of claim 16, wherein the external devices include at least one of a smart watch, a fitness tracker, a biometric sensor device, a video and/or audio device of a home automation system or home security system.

20. The method of claim 16, further comprising:
receiving a command at the emergency application from the PSAP application to generate an alert on the mobile communication device; and
in response to receiving the command, activating at least one of a speaker and a flashlight of the mobile communication device using the emergency application to generate the alert.
